(19) United States
(12) Patent Application Publication
(10) Pub. No.: US 2019/0110433 A1
(43) Pub. Date: Apr. 18, 2019

(54) Insect resistant pet food tray

(71) Applicant: Geoffrey Myers, Indian River, FL (US)

(72) Inventor: Geoffrey Myers, Indian River, FL (US)

(21) Appl. No.: 15/787,417

(22) Filed: Oct. 18, 2017

(51) Int. Cl. A01K 5/01

(52) U.S. Cl. CPC A01K 5/0142

(57) ABSTRACT

The current invention is a pet food tray a bottom reservoir filled with water which is covered by the top that prevent bugs from getting into the pet food. The reservoir is in the base of the tray and is covered with a top so that no contaminants can get into the water. The top edge of the reservoir has a curved lip to prevent spills. The pet tray will accommodate large and small bowls for kibbles, canned food or water.

### CROSS-REFERENCES TO RELATED APPLICATIONS (IF ANY)

None.

### BACKGROUND

### 1. Field of the Invention

The present invention relates generally to an insect resistant pet food tray and in more particularly one with a water moat.

### 2. Description of Prior Art

The problem with most pet food trays is if the pet doesn't finish their food, they can become a breeding ground for bugs and bacteria. Sprays and insecticide can be harmful and even deadly for your pet and family.

There is still room for improvement in the art.

### SUMMARY OF THE INVENTION

The current invention is a pet food tray comprised of a bottom and a top. The pet food tray has a low profile with a bottom reservoir filled with water. This prevent bugs from getting into the pet food. The reservoir is in the base covered with the top tray so that no contaminants can get into the water. The top edge of the reservoir has a curved lip to prevent spills. The pet tray will accommodate large and small bowls for kibbles, canned food or water.

### BRIEF DESCRIPTION OF THE DRAWINGS

Without restricting the full scope of this invention, the preferred form of this invention is illustrated in the following drawings:

FIG. 1 displays the pet food tray;

FIG. 2 shows the bottom part of the tray;

FIG. 3 shows a side view of the pet food tray;

FIG. 4 shows the bottom of the pet food tray; and

FIG. 5 shows the water in the moat.

### DESCRIPTION OF THE PREFERRED EMBODIMENT

There are a number of significant design features and improvements incorporated within the invention.

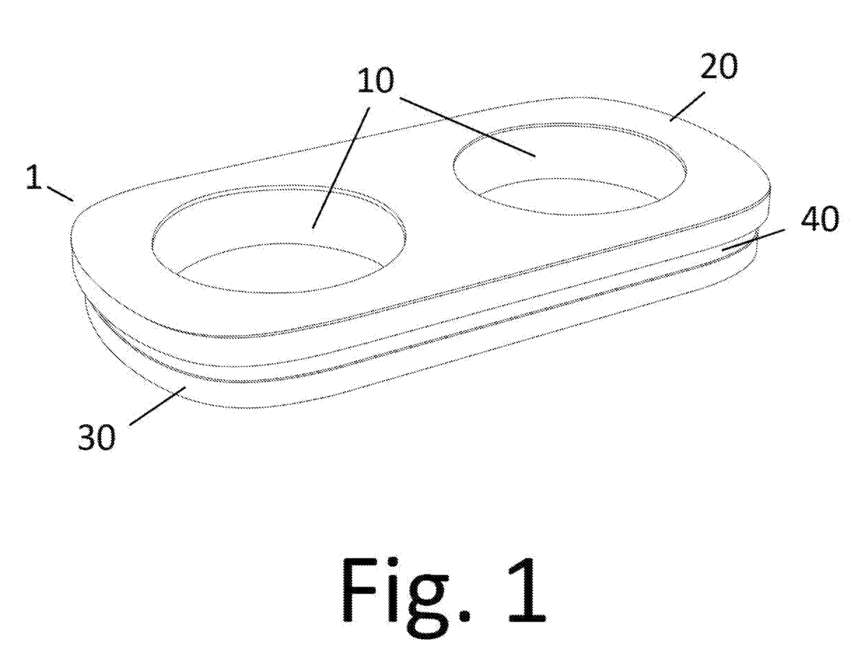

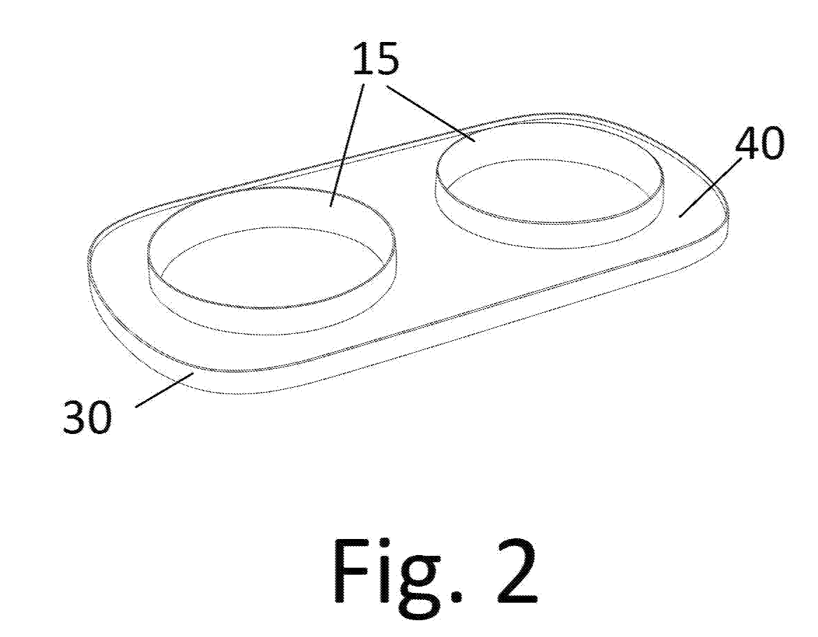

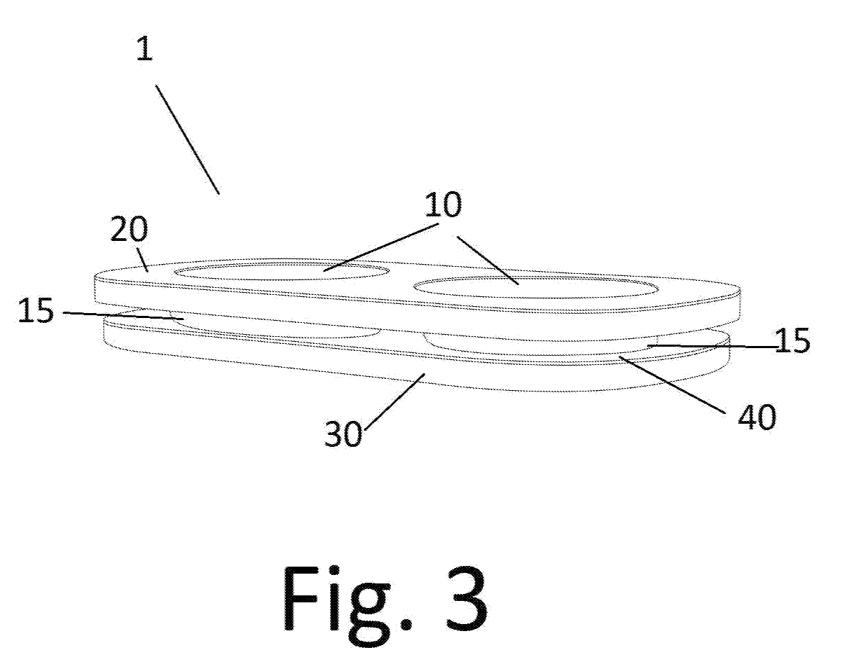

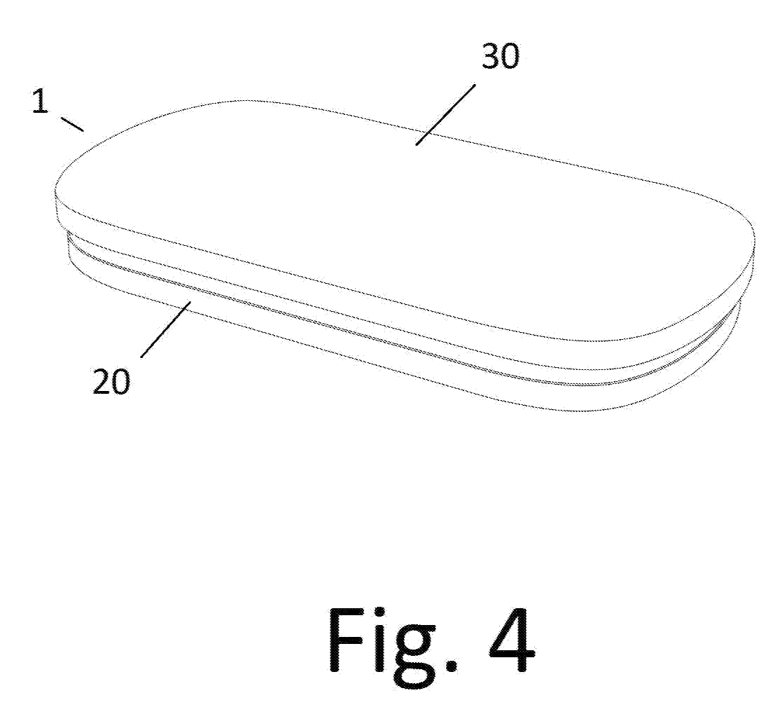

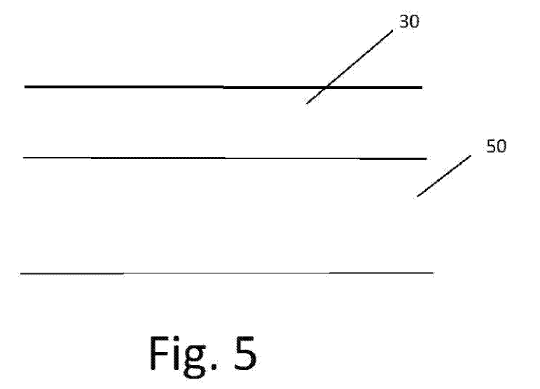

In reference to FIGS. 1 through 5, the present invention consists of a pet food tray 1 with a water moat 40 to prevent bugs from getting into the food.

In the preferred embodiment, the pet food tray 1 is made of a base 30 and a top tray 20 which are combined.

The pet food tray 1 has a low profile with a bottom reservoir 40 filled with water 50, and a top cover tray 20. This prevent bugs from getting into the pet food. The reservoir 40 is in the bottom 30 of the covered with a top 20 so that no contaminants can get into the water. The top edge of the reservoir 40 has a curved lip to prevent spills. The pet tray 1 will accommodate large and small bowls for kibbles, canned food or water.

The top tray 20 rests on the inner walls 15 of the bowl portion of the base 30 with no physical contact with the outer wall. The bowl portion 10 of the top tray 20 nests into the inner walls 15 of the base 30. The sides are slightly tapered to insure a snug fit. The inner walls 15 extend up from the base 30 and are circular matching the bowl portion 10 of the top tray 20.

Both the base 30 and the top tray 20 would have outer rims that extend from the edges. The base 30 outer edge extends perpendicularly up from the edge of the base 30. The top tray 20 outer rim extends perpendicularly down from the edge of the top tray 20. The outer edges of the top tray 20 are curved down to provide rigidity. The base outer walls should curve in mirroring the top tray curve to provide strength and prevent spillage.

The top tray 20 can be easily removed for cleaning and to expose the moat 40 for refilling. There should be a sufficient gap between the base rim and the top tray rim so that bugs cannot cross over to the food area as shown in the Figures.

Additionally removable bowls could nest into the top tray 20 allowing for an option for a higher, larger bowl for large dogs. Otherwise any bowl could be used to make it versatile for all size dogs and cats.

The pet food tray 1 can be rectangular in shape with rounded edges.

Advantages

The current invention provides a simple way of keeping bugs away from a pet food tray. It is a natural and effective way of keeping your pet's food insect-free. It's completely eco-friendly and chemical-free.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. An device comprising:
A pet food tray having a base 30 with a reservoir filled with water.

2. The device according to claim 1 further comparing;
Having a top trayed.

3. The device according to claim 1 further comparing;
Having a top tray and having said top tray connected to the based without the outer sides touching.

4. The device according to claim 2 further comparing;
Where the base has an inner wall and the top tray has a bowl portion where the bowl portion fits into the inner wall.

5. The device according to claim 1 further comparing;
Where the pet food tray is rectangular in shape.
